(19) United States
(12) Patent Application Publication
(10) Pub. No.: US 2017/0094500 A1
(43) Pub. Date: Mar. 30, 2017

(54) SUBSCRIBER IDENTITY MODULE CARD MANAGING METHOD AND ELECTRONIC DEVICE

(71) Applicant: MediaTek Singapore Pte. Ltd., Singapore (SG)

(72) Inventors: Wenxiang Zhong, Chengdou City (CN); YU CHEN, Chengdou City (CN); BEN NIU, Chengdou City (CN)

(21) Appl. No.: 15/092,621

(22) Filed: Apr. 7, 2016

(30) Foreign Application Priority Data
Sep. 30, 2015 (CN) 201510638868.9

(51) Int. Cl. H04W 8/18; H04B 1/3816

(52) U.S. Cl. CPC H04W 8/183; H04B 1/3816; H04W 88/06

(57) ABSTRACT

Subscriber Identity Module (SIM) card managing methods and electronic devices are provided. The SIM card managing method for an electronic device includes: creating a second user environment for a second user under a first user environment for a first user; and setting a predetermined SIM card for a second user via a user input. The user's privacy can thereby be well-protected.

### BACKGROUND

The present invention relates to a managing method for an electronic device, and more particularly, to a subscriber identity module (SIM) card managing method of an electronic device belonging to a plurality of users, and a related electronic device.

If an electronic device comprises a plurality of SIM cards respectively belonging to a plurality of users, when the device owner lends the electronic device to another user, the new user would be able to receive and read the device owner's calls and texts. This is true even when the user switches to a user environment different from the owner's environment in advance, as the different environment will follow the device owner's original settings. In addition, the user can only use the SIM card that correspond to the device owner when making phone calls or sending texts, which results in an inconvenient experience for the user. Therefore, a novel managing method and related electronic device are required to solve the abovementioned problem.

### SUMMARY

In accordance with an aspect of the present invention, a SIM card managing method for an electronic device is provided. The method comprises: creating a second user environment for a second user under a first user environment of a first user; and setting a predetermined SIM card for the second user via an user input. In particular, the predetermined SIM card for the second user is set under the first user environment. And the method further comprises: displaying a SIM card setting option page; and setting the predetermined SIM card for the second user via the user input on the SIM card setting option page.

In accordance with another aspect of the present invention, an electronic device is provided. The electronic device comprises: a user managing circuitry, arranged to create a second user environment for a second user under a first user environment of a first user; and a SIM card manage circuitry, arranged to set a predetermined SIM card for the second user via a user input. In particular, the SIM card manage circuitry sets under the first user environment. And the SIM card manage circuitry further comprises: a display circuitry arranged to display a SIM card setting option page; and the SIM card manage circuitry sets the predetermined SIM card for the second via the user input on the SIM card setting option page.

In accordance with yet another aspect of the present invention, an electronic device is provided. The electronic device comprises: a storage device, arranged to store a program code; and a processor, arranged to execute the program code and thereby manipulate the electronic device to perform the steps of: creating a second user environment for a second user under a first user environment of a first user; and setting a predetermined SIM card for the second user via an user input.

Through the disclosed embodiments of the present invention, a user's privacy can be well-protected.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating setting a new predetermined SIM card according to an embodiment of the present invention.

FIG. 2 is a diagram illustrating following an original SIM card setting according to an embodiment of the present invention.

FIG. 3 is a flowchart illustrating a SIM card managing method according to an embodiment of the present invention.

FIG. 4 is a diagram illustrating setting a predetermined SIM card according to another embodiment of the present invention.

FIG. 5 is a flowchart illustrating a SIM card managing method according to another embodiment of the present invention.

FIG. 6 is a diagram illustrating setting a predetermined SIM card according to another embodiment of the present invention.

FIG. 7 is a flowchart illustrating a SIM card managing method according to another embodiment of the present invention.

FIG. 8 is a diagram illustrating an electronic device according to an embodiment of the present invention.

FIG. 9 is a diagram illustrating an electronic device according to an embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should not be interpreted as a close-ended term such as “consist of”. Also, the term “couple” is intended to mean either an indirect or direct electrical connection. Accordingly, if one device is coupled to another device, that connection may be through a direct electrical connection, or through an indirect electrical connection via other devices and connections.

An embodiment of the present invention discloses a SIM card managing method executed by a first user (e.g., device owner) of an electronic device 10. The electronic device 10 may comprise a plurality of SIM cards. If the electronic device comprises only one single SIM card (e.g. a first SIM card), the electronic device operates in a single card environment; if the electronic device comprises a plurality of SIM cards (e.g. the first SIM card and a second SIM card), the electronic device 10 operates in a multiple cards environment.

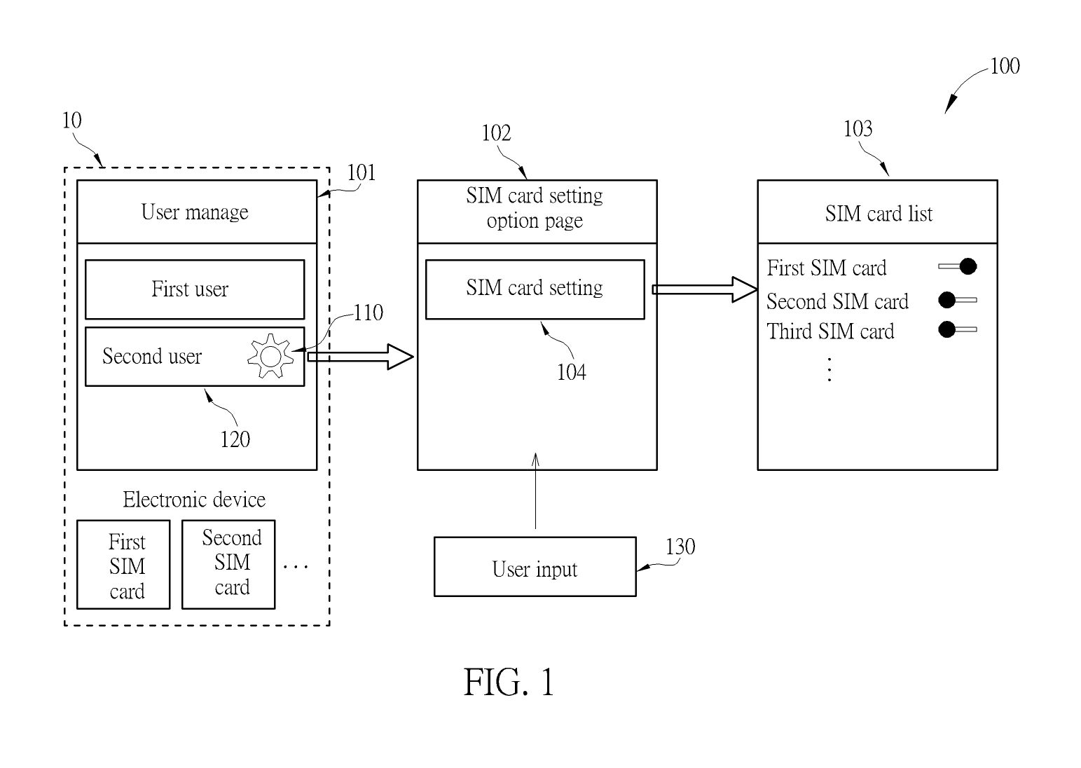

FIG. 1 is a diagram illustrating setting a new predetermined SIM card according to an embodiment of the present invention. In this embodiment, the first user can create a second user environment of a second user (e.g., who is not the device owner) in a user manage interface 101 of a first user environment 100. The user manage interface 101 is displayed on a user interface such as a display screen of the electronic device 10. A SIM card setting option page 102 can then be entered, which corresponds to the second user. The SIM card setting option page 102 may comprise a SIM card setting label 104. After selecting the SIM card setting label 104 via a user input 130 of the first user, a SIM card in a SIM card list 103 of the SIM card setting option page 102 can be selected as a predetermined SIM card of the second user. The SIM card list 103 lists the plurality of SIM cards in the electronic device 10 so that the first user can select and set the predetermined SIM card for the second user. In another embodiment, the SIM card list 103 can directly be shown on the SIM card setting option page 102 without selecting the SIM card setting label 104. It should be noted that, for an electronic device with a plurality of users, the user uses the electronic device by logging into their own account. At this time, the operating environment (e.g. system setting) of the electronic device can be referred to as a user environment.

After the first user creates the second user environment, the SIM card setting option page 102 may emerge manually or automatically. For example, after the first user creates the second user environment, the SIM card setting option page 102 can be entered automatically so the first user can set the predetermined SIM card. In another example, after the first user creates the second user environment, the setting operation can be executed through a setting option 110 of a second user label 120 on the user manage interface 101. As shown in FIG. 1, after selecting the setting option 110 of the second user label 120, the SIM card setting option page 102 is entered to set the predetermined SIM card of the second user. In other words, the present invention does not limit the method of entering the SIM card setting option page 102.

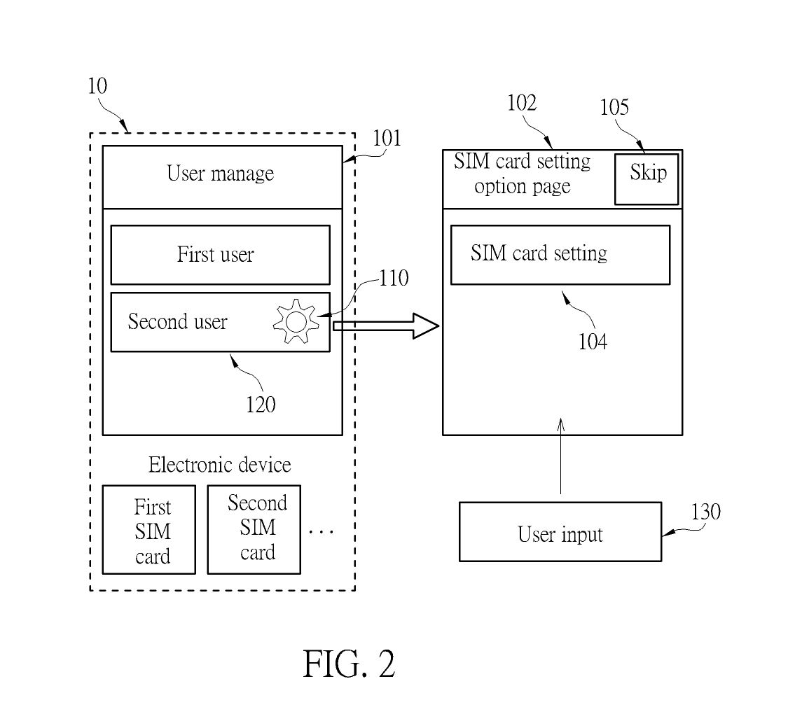

FIG. 2 is a diagram illustrating following the original SIM card setting according to an embodiment of the present invention. After creating the second user environment, if the user input 130 of the first user selects a skip label 105 on the SIM card setting option page 102 (i.e. selects to move to other pages without entering the SIM card list 103), then an original SIM card for the first user is set to be the predetermined SIM card for the second user. This means the first user's SIM card is used as the predetermined SIM card for the second user.

It should be noted that, if the first user desires to select the original SIM card as the predetermined SIM card for the second user, the first user can also select the original SIM card in the SIM card list 103 after selecting the SIM card setting label 103 shown in FIG. 1. For example, if the original SIM card is a the first SIM card, the first user can select the first SIM card in the SIM card list 103 as the predetermined SIM card for the second user.

The user input 130 of the first user may be a touch operation, an operation via a button, or an operation via remote control. For example, if the electronic device is a smart phone with a touch panel, the user input 130 can be a touch operation on the electronic device to select the predetermined SIM card for the second user via touching the SIM card setting label 104 in FIG. 1 or the skip label 105 in FIG. 2. If the electronic device is a conventional mobile phone, the user input 130 may be executed by pressing a button on the phone. Therefore, the present invention does not limit the form of the user input 130. After setting the predetermined SIM card for the second user, the first user can still select another SIM card in the SIM card list 103 after selecting the setting option 110 and entering the SIM card setting option page 102 on the user manage interface 101, to thereby reset the predetermined SIM card for the second user.

When the electronic device 10 only comprises the original SIM card (i.e. only one single SIM card is installed), after the first user creates the second user, the first user environment 100 directly uses the original SIM card as the predetermined SIM card for the second user, i.e. the SIM card setting option page 102 is not entered for the first user to select. For example, when the electronic device 10 only comprises the first SIM card, after the first user creates the second user, the first user environment 100 sets the first SIM card as the predetermined SIM card for the second user directly.

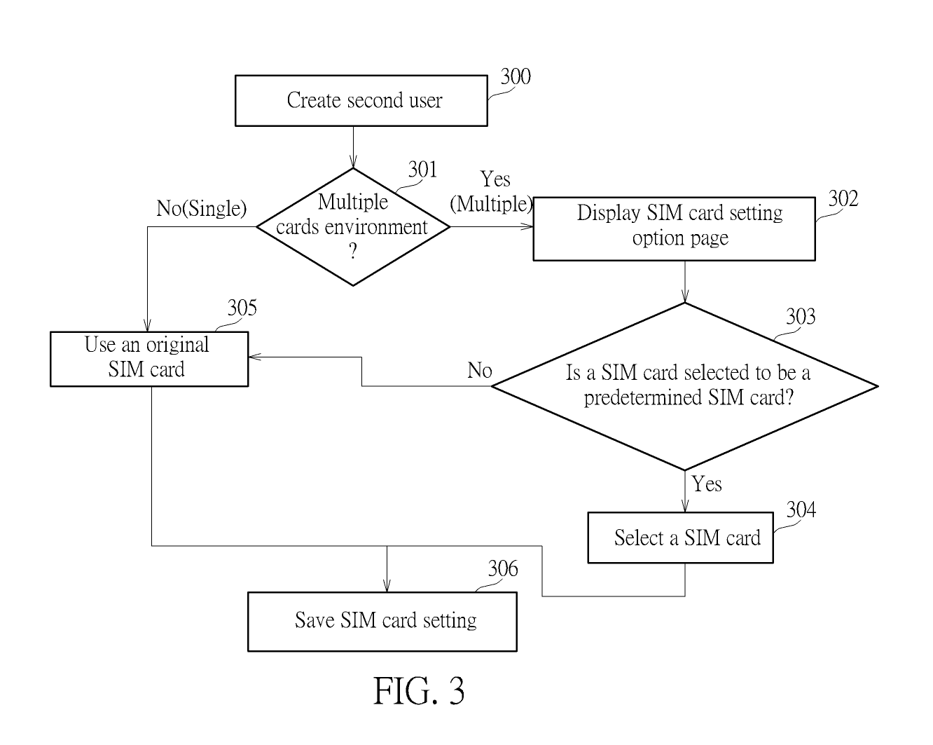

FIG. 3 is a flowchart illustrating a SIM card managing method according to an embodiment of the present invention. Provided that the result is substantially the same, the steps are not required to be executed in the exact order shown in FIG. 3. The SIM card managing method can be summarized as follows:

Step 300: create a second user environment 200 for a second user under a first user environment 100 for the first user.

Step 301: determine whether the electronic device 10 comprises a plurality of SIM cards; if yes, go to step 302; otherwise, go to step 305.

Step 302: display a SIM card setting option page 102.

Step 303: is a SIM card selected as a predetermined SIM card for the second user? If yes, go to step 302; otherwise, go to step 305.

Step 304: select a SIM card in the SIM card list 103 as the predetermined SIM card for the second user. Go to Step 306.

Step 305: use an original SIM card for the first user as the predetermined SIM card for the second user. Go to Step 306.

Step 306: save the predetermined SIM card setting for the second user.

Those skilled in the art can readily understand details of each step shown in FIG. 3 after reading the above paragraphs. Some steps may be added or skipped (e.g., step 303) without violating the main purpose of the present invention. These alternative designs also fall within the scope of the present invention.

Another embodiment of the present invention discloses a SIM card managing method executed by a second user of the electronic device 10. As previously mentioned, the electronic device 10 can install a plurality of SIM cards. If the electronic device 10 installs a single SIM card (e.g. the first SIM card), the electronic device 10 operates in the single card environment; if the electronic device 10 installs a plurality of SIM cards (e.g. the first SIM card, the second SIM card, etc.), the electronic device 10 operates in the multiple cards environment.

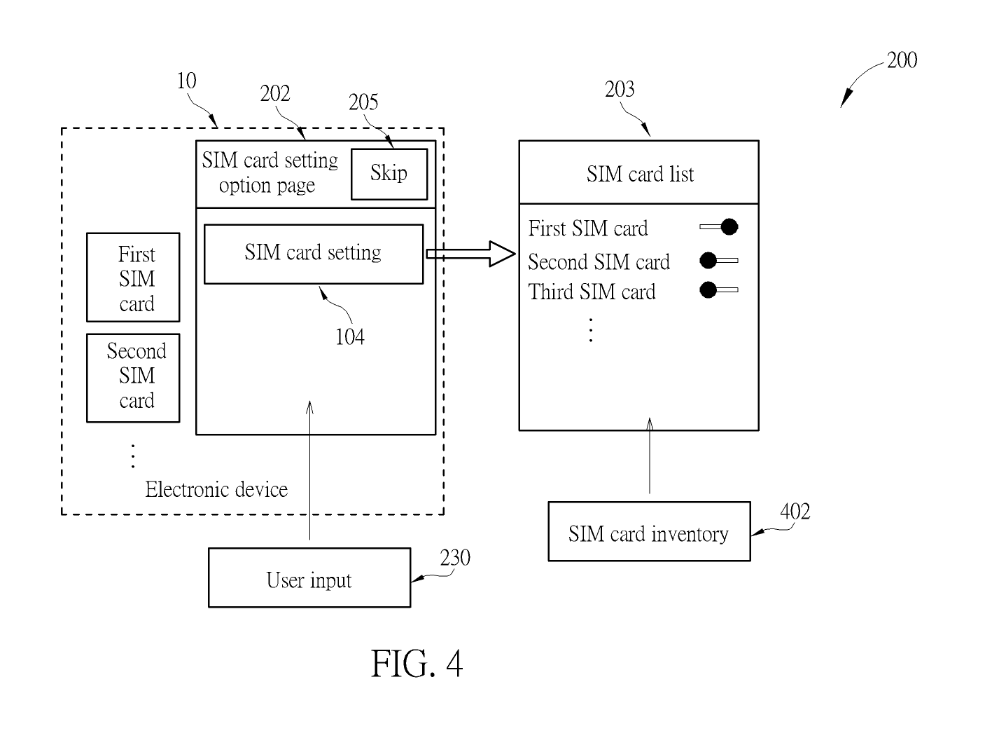

FIG. 4 is a diagram illustrating setting a predetermined SIM card according to another embodiment of the present invention. In this embodiment, the first user creates the second user environment 200 for the second user in the first user environment 100, and then switches to the second user environment 200 from the first user environment 100. At this time, the predetermined SIM card for the second user has not yet been set. The second user then enters a SIM card setting option page 202 (displayed on a user interface such as a display screen of the electronic device 10) under the second user environment 200. The SIM card setting option page 202 comprises a SIM card setting label 204. After selecting the SIM card setting label 204 via a user input 230 of the second user, the second user can select a SIM card in a SIM card list 203 as the predetermined SIM card for the second user. The SIM card list 203 lists the plurality of SIM cards in the electronic device 10 which can be set by the second user as the predetermined SIM card. Similar to the aforementioned embodiments, the SIM card setting label 204 can be skipped. It should be noted that, after switching to the second user environment 200, the SIM card setting option page 202 may emerge manually or automatically. For example, after switching to the second user environment 200, the SIM card setting option page 202 is entered automatically for the second user to set the predetermined SIM card. In another example, after switching to the second user environment 200, the setting operation can be executed by the second user on a user manage interface which is similar to the user manage interface 101. Detailed description is thus omitted here for brevity.

After switching to the second user environment 200, if the user input 230 of the second user selects a skip label 205 on the SIM card setting option page 202 (i.e. by moving to other pages without entering the SIM card list 203), the second user environment 200 sets the original SIM card for the first user as the predetermined SIM card for the second user. It should be noted that if the second user desires to select the original SIM card as the predetermined SIM card, the second user can still select the original SIM card in the SIM card list 203 after selecting the SIM card setting label 204 shown in FIG. 4. In addition, the user input 230 of the second user may be a touch operation, an operation via a button, or an operation via remote control. The present invention does not limit the form of the user input 230. After setting the predetermined SIM card for the second user, the second user can still select another SIM card on the user manage interface as the predetermined SIM card, in a similar way to the previous embodiment. The detailed description is thus omitted. In addition, in an embodiment, when the electronic device 10 only comprises the original SIM card, after switching to the second user environment 200, the second user environment 200 uses the original SIM card as the predetermined SIM card without displaying the SIM card setting option page 202 for the second user.

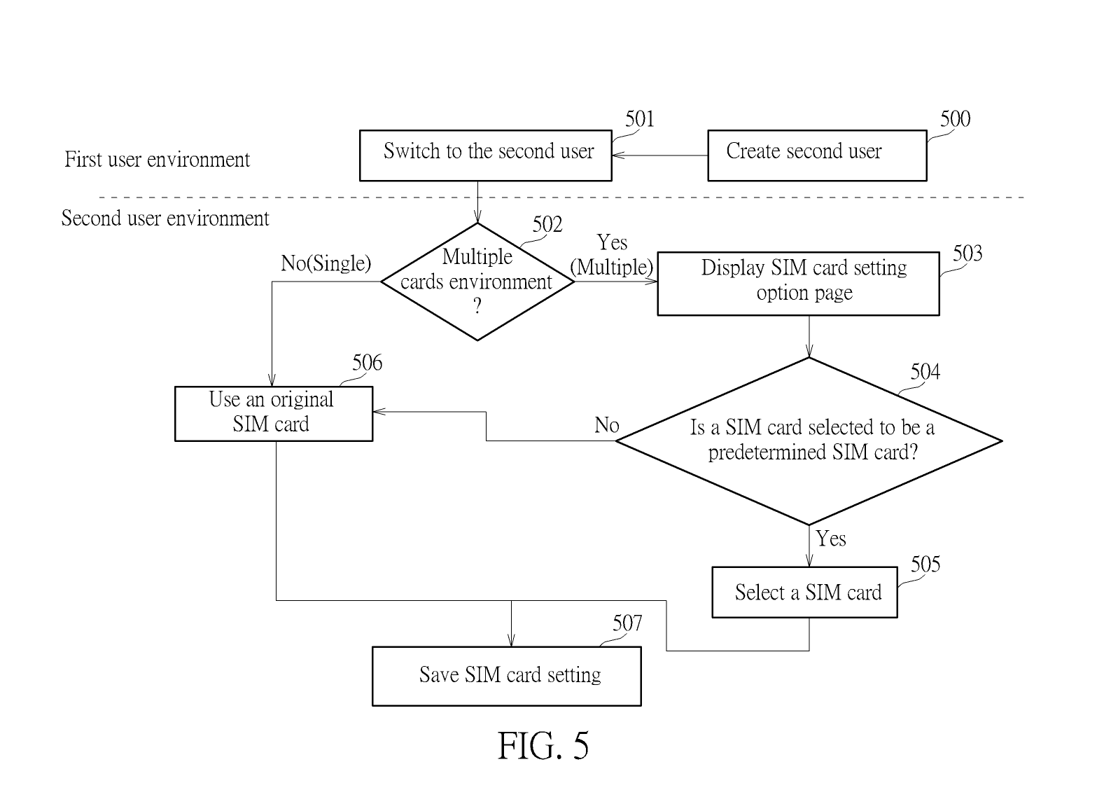

FIG. 5 is a flowchart illustrating a SIM card managing method according to another embodiment of the present invention. Provided that the result is substantially the same, the steps are not required to be executed in the exact order shown in FIG. 5. The SIM card managing method can be summarized as follows:

Step 500: create a second user environment 200 for the second user under a first user environment 100 for the first user, and go to step 501.

Step 501: switch to the second user environment 200 from the first user environment 100, and go to step 502.

Step 502: determine whether the electronic device 10 comprises a plurality of SIM cards; if yes, go to step 503; otherwise, go to step 506.

Step 503: display a SIM card setting option page 202.

Step 504: Is a SIM card selected as the predetermined SIM card? If yes, go to step 505; otherwise, go to step 506.

Step 505: select a SIM card in a SIM card list 203 as the predetermined SIM card, and go to step 507.

Step 506: use the original SIM card for the first user as the predetermined SIM card, and go to step 507.

Step 507: save the predetermined SIM card setting for the second user.

Those skilled in the art can readily understand details of each step shown in FIG. 5 after reading the above paragraphs. Some steps may be added or skipped without violating the main purpose of the present invention. These alternative designs also fall within the scope of the present invention.

In an alternative design, the SIM cards listed in the SIM card list 203 shown in FIG. 4 are not required to comprise all of the SIM cards in the electronic device 10. In another embodiment, the first user can set a SIM card inventory 402 under the first user environment 100, and assign any SIM card to the SIM card inventory 402. According to the setting by the first user, the SIM card inventory 402 can be a list comprising one or more SIM cards. When switching to the second user environment 200, the second user can only select the SIM cards in the SIM card inventory 402 as the predetermined SIM card for the second user. Assume the electronic device 10 comprises four SIM cards, e.g. the first SIM card, the second SIM card, a third SIM card and a fourth SIM card. The first user assigns the first SIM card, the second SIM card and the third SIM card to the SIM card inventory 402. After switching to the second user environment 200, the SIM card list 203 corresponding to the SIM card inventory 402 only displays the first SIM card, the second SIM card and the third SIM card. Therefore, the second user can only select one of the first SIM card, the second SIM card and the third SIM card as the predetermined SIM card. The fourth SIM card cannot be selected as the predetermined SIM card, as it is not listed in the SIM card inventory 402.

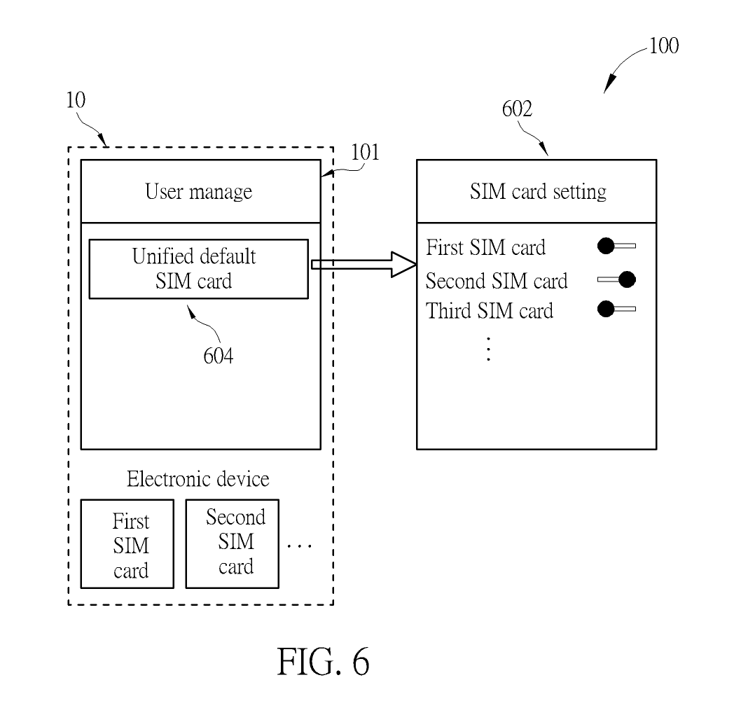

Another embodiment of the present invention discloses a SIM card managing method executed by the first user of the electronic device 10. As previously mentioned, a plurality of SIM cards may be installed in the electronic device 10. FIG. 6 is a diagram illustrating setting a predetermined SIM card according to another embodiment of the present invention. In this embodiment, the user manage interface 101 of the first user environment 100 comprises a unified default SIM card label 601. After the first user selects the unified default SIM card label 601 and enters the SIM card setting page 602, the first user can select one of the plurality of SIM cards in the electronic device 10 as the predetermined SIM card for other users who are not the device owner. For example, when the first user selects the second SIM card in the SIM card setting page 602 as the predetermined SIM card for other users except for the first user, the second user environment 200 sets the second SIM card as the predetermined SIM card directly.

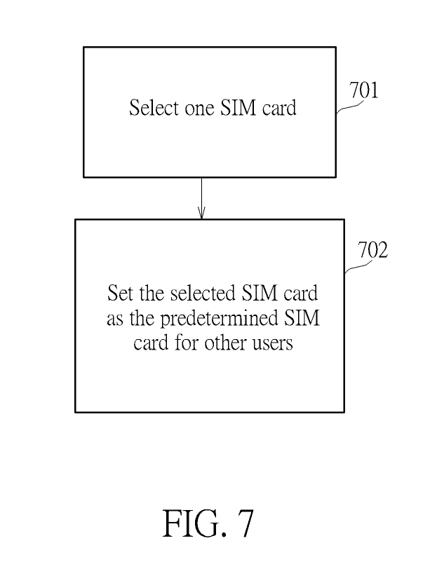

FIG. 7 is a flowchart illustrating a SIM card managing method according to another embodiment of the present invention. Provided that the result is substantially the same, the steps are not required to be executed in the exact order shown in FIG. 7. The SIM card managing method can be summarized as follows:

Step 701: select one of the plurality of SIM cards in the electronic device 10 under the first user environment 100, and go to step 702.

Step 702: set the selected SIM card as the predetermined SIM card for other users except for the first user.

Those skilled in the art can readily understand details of each step shown in FIG. 7 after reading the above paragraphs directed to the SIM card managing method.

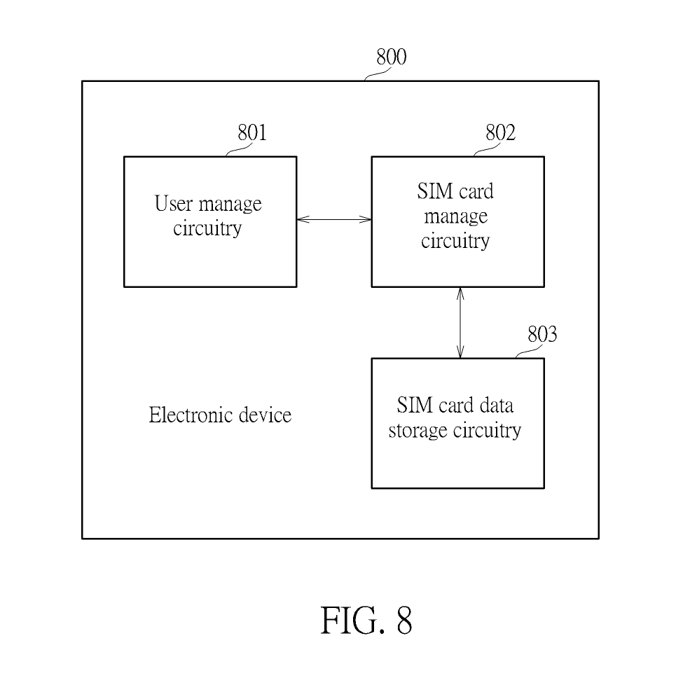

FIG. 8 is a diagram illustrating an electronic device 800 according to an embodiment of the present invention. As shown in FIG. 8, the electronic device 800 comprises a user manage circuitry 801, a SIM card manage circuitry 802 and a SIM card data storage circuitry 803. The user manage circuitry 801 is arranged to create, modify, delete or switch a user/user environment. For example, the user manage circuitry 801 can create the second user environment for the second user under the first user environment for the first user. In another embodiment, the user manage circuitry 801 can create a default SIM card list under the first user environment for the first user. The SIM card manage circuitry 802 may set the predetermined SIM card for the second user under the first user environment or the second user environment. In an embodiment, the SIM card manage circuitry 802 can further comprise a display circuitry (not shown in FIG. 8) to display a SIM card setting option and set the predetermined SIM card for the second user via a user input corresponding to the SIM card setting option. When the user input skips the SIM card setting option, the SIM card manage circuitry 802 uses the predetermined SIM card for the first user as the predetermined SIM card for the second user. In another embodiment, the SIM card manage circuitry 802 selects a SIM card under the first user environment for the first user, and sets the SIM card as the predetermined SIM card for other users of other user environments. The SIM card data storage circuitry 803 is arranged to store the predetermined SIM setting for each user.

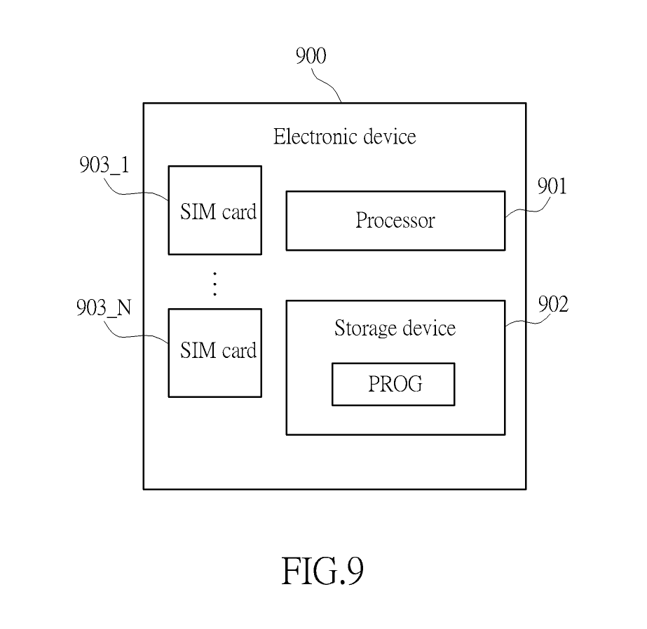

FIG. 9 is a diagram illustrating an electronic device according to an embodiment of the present invention, wherein the electronic device 900 comprises a processor 901 and a storage device 902 storing a program code PROD. The electronic device 10 can be implemented by the electronic device 900. A plurality of SIM cards 903_1-903_N can be installed in the electronic device 900. When the program code PROG is loaded and executed by the processor 901, the processor 901 executes the steps shown in FIG. 3, FIG. 5 and/or FIG. 7. Those skilled in the art can readily understand details of the SIM card managing operation after reading the above paragraphs. Detailed description is thus omitted here for brevity.

The present invention can ensure the user's privacy is well-protected. Although the present invention discloses that the electronic device comprises a plurality of SIM cards or a plurality of SIM cards are installed in the electronic device, one skilled in the art should readily understand that the electronic device may comprise a plurality of SIM card slots. In other words, the electronic device comprising a plurality of SIM cards or a plurality of SIM cards installed in the electronic device mentioned in the present invention should be considered as an electronic device comprising a plurality of actual SIM cards and/or an electronic device comprising a plurality of SIM cards slots.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A Subscriber Identity Module (SIM) card managing method for an electronic device, comprising:
creating a second user environment for a second user under a first user environment for a first user; and
setting a predetermined SIM card for the second user via a user input.

2. The SIM card managing method of claim 1, wherein the predetermined SIM card for the second user is set under the first user environment.

3. The SIM card managing method of claim 1, wherein the predetermined SIM card for the second user is set under the second user environment.

4. The SIM card managing method of claim 1, wherein the electronic device comprises a plurality of SIM cards, and the method further comprises:
displaying a SIM card setting option page; and
setting the predetermined SIM card for the second user via the user input on the SIM card setting option page.

5. The SIM card managing method of claim 4, wherein the step of setting the predetermined SIM card for the second user via the user input on the SIM card setting option page comprises:
when the user input skips SIM card setting option without selecting any SIM card, setting a SIM card for the first user as the predetermined SIM card for the second user.

6. The SIM card managing method of claim 1, wherein a plurality of SIM cards can be installed in the electronic device, and the plurality of SIM cards comprise a first SIM card and a second SIM card, the step of setting the predetermined SIM card for the second user comprises setting the first SIM card as the predetermined SIM card for the second user, and the method further comprises:
after setting the predetermined SIM card for the second user, changing the predetermined SIM card from the first SIM card to the second SIM card under the first user environment for the first user.

7. The SIM card managing method of claim 3, wherein a plurality of SIM cards can be installed in the electronic device, and the step of setting the predetermined SIM card for the second user comprises:
setting the predetermined SIM card for the second user via a default SIM card inventory, wherein the default SIM card inventory is created under the first user environment for the first user.

8. An electronic device, comprising:
a user manage circuitry, arranged to create a second user environment for a second user under a first user environment for a first user; and
a Subscriber Identity Module (SIM) card manage circuitry, arranged to set a predetermined SIM card for the second user via a user input.

9. The electronic device of claim 8, wherein the SIM card manage circuitry sets the predetermined SIM card for the second user under the first user environment.

10. The electronic device of claim 8, wherein the SIM card manage circuitry sets the predetermined SIM card for the second user under the second user environment.

11. The electronic device of claim 8, wherein a plurality of SIM cards can be installed in the electronic device, and the SIM card manage circuitry further comprises a display circuitry arranged to display a SIM card setting option page; and the SIM card manage circuitry sets the predetermined SIM card for the second via the user input on the SIM card setting option page.

12. The electronic device of claim 11, wherein when the user input skips SIM card setting option without selecting any SIM card, the SIM card manage circuitry sets a SIM card for the first user as the predetermined SIM card for the second user.

13. The electronic device of claim 8, wherein a plurality of SIM cards can be installed in the electronic device, and the plurality of SIM cards comprise a first SIM card and a second SIM card, and wherein after setting the predetermined SIM card for the second user, the SIM card manage circuitry changes the predetermined SIM card from the first SIM card to the second SIM card under the first user environment for the first user.

14. The electronic device of claim 10, wherein a plurality of SIM cards can be installed in the electronic device, and the SIM manage circuitry sets the predetermined SIM card for the second user via a default SIM card inventory, wherein the default SIM card inventory is created under the first user environment for the first user by the user manage circuitry.

15. An electronic device, comprising:
a storage device, arranged to store a program code; and
a processor, arranged to execute the program code and thereby manipulate the electronic device to perform the steps of:
creating a second user environment for a second user under a first user environment for a first user; and
setting a predetermined SIM card for the second user via a user input.
